(19) United States
(12) Patent Application Publication
(10) Pub. No.: US 2023/0061078 A1
(43) Pub. Date: Mar. 2, 2023

(54) ATTACHMENT SYSTEM FOR A SEAT COVERING

(71) Applicant: Huyan Fang, Secaucus, NJ (US)

(72) Inventor: Huyan Fang, Secaucus, NJ (US)

(21) Appl. No.: 17/446,523

(22) Filed: Aug. 31, 2021

(51) Int. Cl. B60N 2/58; B60N 2/894

(52) U.S. Cl. CPC B60N 2/5825; B60N 2/894

(57) ABSTRACT

An attachment system for a vehicular seat covering, the attachment system having an engagement portion and an extension portion. The engagement portion removably engages an upper portion of the vehicular seat and the extension portion interconnects the engagement portion and the seat covering extending from a proximal end of the extension portion. Opposite the seat covering, the extension portion provides a plurality of attachment points to which the engagement portion can selectively attach. Thereby, the elevation of the dependent seat covering is selectively adjustable through selecting one of the plurality of attachment points from which to hang the extension portion from the engagement portion.

### BACKGROUND OF THE INVENTION

The present invention relates to vehicular seat covers and, more particularly, an attachment system for seat coverings including an adjustable hook attachment for selectively attaching a seat cover relative to an upper portion of a vehicular seat.

Many vehicular seat covers and bucket seat cushions currently being sold on the market are often advertised as secure fits, but they do not always come equipped with options for adjustably securing the seat covers to and/or over the seat. This can force the consumer to attempt to install a seat cover that is too small or too large, often resulting in poor sizing, which in turn leading to an uncomfortable user experience, thereby requiring the user to again refasten the seat cover.

While most car seat cushions are designed to fit a variety of cars, they do not feature any additional attachments or hardware that allows the user to adjust the height and fit of the seat cover/cushion to different sizes and types of vehicular seats.

Because most car seat cushions do not have any adjustable features, this means these seat covers/cushions cannot accommodate any slight deviations in seat size, which of course are determined by the vehicle manufacturers not the vehicle seat cover manufacturers. This forces the customer to try to install a cushion cover that may be too big or too small, resulting in a poor fit and possibly a frustrating installation experience and an uncomfortable driving experience.

As can be seen, there is a need for an attachment system for vehicular seat coverings wherein the attachment system embodies an engagement portion and a an extension portion, wherein the engagement portion is adapted to engage a headrest portion of the vehicular seat, and wherein the extension portion enables the user to selectively locate the distal end of the extension portion (i.e., the end from which the seat cover depends) among one of a plurality of positions relative to the headrest and/or upper portion of the vehicular seat being covered. Since the seat covering extends from the distal end, thus the seat covering's location and thus fit relative to the vehicular seat is adjustable to produce a comfortable fit.

In one embodiment, the adjustable engagement portion may be a horizontal bar attachment and a flexible and durable extension portion. The horizontal bar attachment may provide two hook portions, one on each opposing end of the horizontal bar, thereby enabling the user to engage or latch to headrest supports of the headrest of the vehicular seat. The extension portion provides a plurality of pockets/slots vertically positioned/arranged relative to each other, where each pocket offers support for the horizontal bar attachment at different vertical positions. Making the dependent seat covering (e.g., the seat cushion or cover) adjustable in elevation relative to the upper portion of the vehicular seat. Accordingly, the seat covering is adjustable to accommodate slightly longer or shorter vehicular seats based on the unique size of any vehicle's make and model.

The innovation lies in the horizontal bar hook, located at the base of the headrest and supporting a distal end of the extension portion at one of a plurality of vertical elevations. Unlike other universal fit cushions, the seat covering can be slightly adjusted to accommodate a range of seat heights (vertical elevations). The present invention gives vehicular seat covers the option of adjustably fitting both low and high back seats in a variety of vehicles.

The extension portion may include two or more different slot positions and is fitted with a horizontal bar hook that latches onto a seat's headrest support and/or upper portion of the vehicular seat. The bar hook can be removed and reinserted into any the different slots, creating a range of positions that will accommodate most bucket seats and headrests.

### SUMMARY OF THE INVENTION

In one aspect of the present invention, a vehicular seat attachment system, the system includes the following: an engagement portion having one or more latches; and an extension portion having a plurality of attachment points, wherein the engagement portion removably attaches to one of the plurality of attachment points, and wherein the plurality of attachment points are linearly spaced apart relative to each other.

In another aspect of the present invention, the system further includes wherein the engagement portion is elongated, wherein the one or more latches are recesses along a longitudinal edge of the engagement portion, wherein each attachment point is elongated, wherein each attachment point is a pocket; and further including a vehicular seat having an upper portion to which the engagement portion removable latches to, wherein the upper portion comprises one or more headrest bases to which the one or more latches abut or wherein the upper portion comprises one or more headrest supports to which the one or more latches abut; and further including a seat covering extending from a proximal end of the extension portion.

In yet another aspect of the present invention, an attachment system includes an elongate engagement portion having one or more attachment portion connecting to a first object; and an extension portion having a plurality of elongated pockets, wherein the elongated engagement portion removably slides in one of the plurality of elongated pockets, and wherein the plurality of elongated pockets are linearly spaced apart relative to each other wherein a distance between the elongated engagement portion and a proximal end of the extension portion is adjustable between two or more connections to the first object, and wherein the proximal end connects to a second object.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use.

FIG. 2 is an exploded perspective view of an exemplary embodiment of the present invention.

FIG. 3 is a section view of an exemplary embodiment of the present invention, taken along line 3-3 in FIG. 1, showing a hook portion in a first position.

FIG. 4 is a section view similar to FIG. 3, showing the hook portion in a second position.

FIG. 5 is a section view similar to FIG. 3, showing the hook portion in a third position.

FIG. 6 is a section view of an exemplary embodiment of the present invention, taken along line 6-6 in FIG. 5, showing the extender with the hook portion in the first position and the first and second position shown in phantom.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an attachment system for a vehicular seat covering. The attachment system includes an engagement portion and an extension portion. The engagement portion removably engages an upper portion of the vehicular seat wherein the extension portion interconnects the engagement portion and the seat covering extending from a proximal end of the extension portion. Opposite the seat covering, the extension portion provides a plurality of attachment points to which the engagement portion can selectively attach to. Thereby, the elevation of the dependent seat covering is selectively adjustable through selecting one of the plurality of attachment points from which to hang the extension portion from the engagement portion.

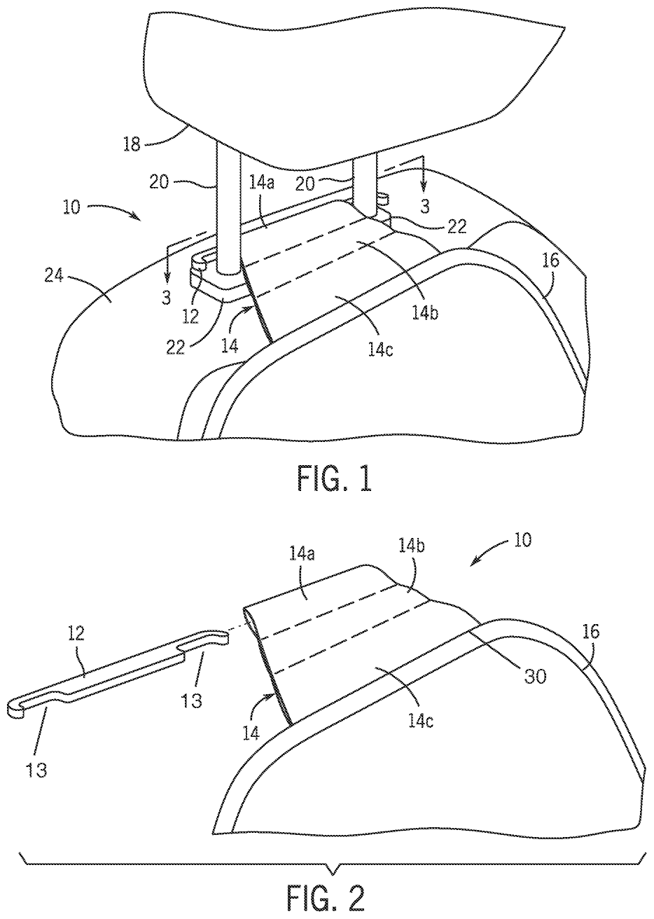

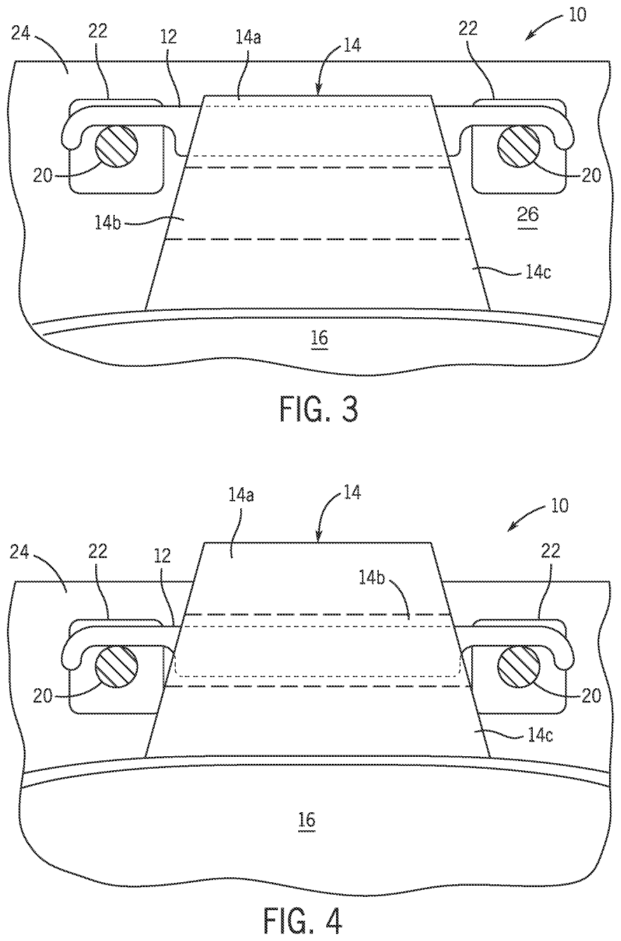

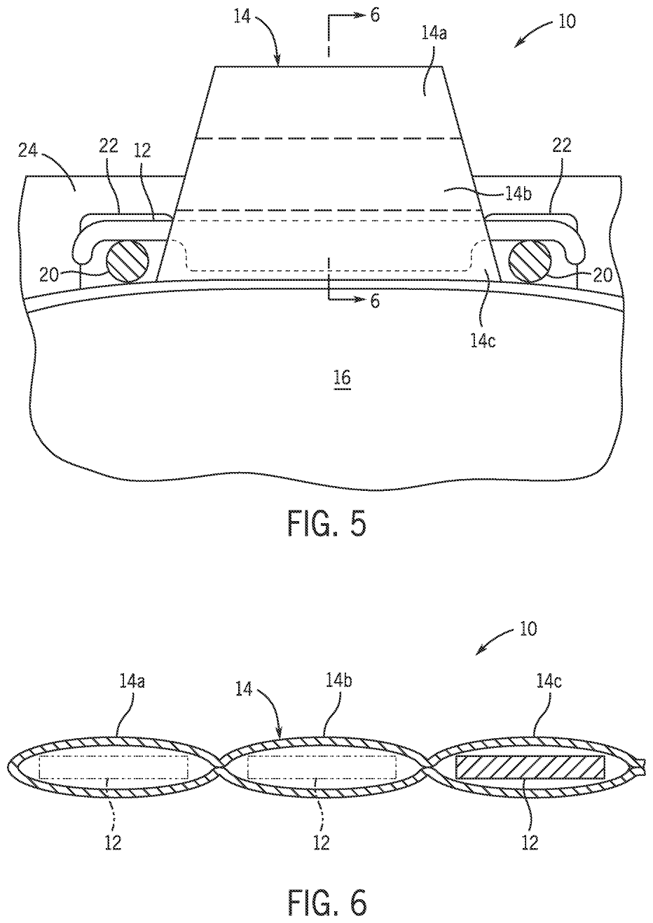

Referring now to FIGS. 1 through 6, the present invention may include an attachment system 10 for seat coverings 16. The attachment system 10 may include an engagement portion 12 and an extension portion 14.

The engagement portion 12 may be dimensioned and adapted to engage a headrest supports 20 of a headrest 18 of a vehicular seat 24. These headrest supports 20 may include any type of members extending from the headrest 18, wherein each member movably couples to a headrest base 22 along an upper portion 26 of the vehicular seat 24.

The engagement portion 12 may be generally elongated in shape—i.e., having a length greater than a width—and have an engagement structure 13 at or adjacent to each longitudinal end of the engagement portion 12. The engagement structure 13 may be a recess along one longitudinal edge of the elongated engagement portion 12, hook-shaped elements, or any structure or components capable of latching on or connecting to a headrest support 20/upper portion 26 of the vehicular seat 24. It is also contemplated that the headrest support 20 consists of one element, and that one element may or may not be movable relative to the upper portion 26 of the vehicle seat 24. In this embodiment, the engagement structure 13 may be one recess/hook-shaped element dimensioned and adapted to engage the one headrest support 20 so that the present invention functions as disclosed herein. It is also contemplated that the attachment system 10 works without a headrest 18, wherein the engagement structure 13 is adapted to engage the upper portion 26 of the vehicular seat 24 and/or the headrest bases 22 (for example, the engagement structure 13 has shown in the FIGS. could be dimensioned to latch onto the rectangular (or other geometric and not-geometric shapes, such as circular or the like) headdress bases 22 that protrude from the upper portion of the vehicular seat 24.

The extension portion 14 may include a plurality of attachment points 14a, 14b, 14c, . . . 14n (not shown), etc., arranged consecutively, wherein each attachment point is dimensioned and adapted to removably secure the engagement portion 12. In certain embodiments, the attachment points are pockets, slots. or sleeves dimensioned to slidably receive the engagement portion 12. Though it is understood other structure, sufficient to removably engage the engagement portion 12 along consecutive vertical elevations/positions may be alternatively provided. The result of the consecutively arranged attachment points is that the engagement portion 12 can be selectively placed in anyone of the attachment points while the engagement portion 12 is engaged with the vehicular seat 24. As a result, a distal end 30 of the extension portion 14 may be selectively positioned relative to the headrest 18/headrest supports 20 and (because gravity tends to push the engagement portion 12 downward) thus to the headrest bases 22/upper portion of the vehicular seat 24. The extension portion 14 may be made from fabric, leather, various plasticized material, or the like.

Accordingly, a seat covering 16 depending from the proximal end 30 of the extension portion 14 is selectively adjustable along the vehicular seat 24 to which the headrest 18 is connected to. Therefore, the seat covering 16 is adjustable to accommodate slightly longer or shorter vehicular seats 24 based on the unique size of any vehicle's make and model. The seat covering 16 may be a seat cushion, a seat cover, or the like.

A method of using the present invention may include the following. The attachment system 10 for seat coverings 16 disclosed above may be provided., wherein extending from the proximal end of the extension portion 14 is the seat covering 16. A user may select the attachment point 14a, 14b, 14c . . . 14n that the engagement portion 12 is secured by/in, and then latches the engagement structure 13 to the headrest support(s) 20 so that the seat covering 16 desirably engages the back support portion and/or seat portion of the vehicular seat 24.

It should be understood, of course, that the foregoing relates to exemplary embodiments of the invention and that modifications may be made without departing from the spirit and scope of the invention as set forth in the following claims.

What is claimed is:

1. A vehicular seat attachment system, the system comprising:
an engagement portion having one or more latches; and
an extension portion having a plurality of attachment points, wherein the engagement portion removably attaches to one of the plurality of attachment points, and wherein the plurality of attachment points are linearly spaced apart relative to each other.

2. The system of claim 1, wherein the engagement portion is elongated.

3. The system of claim 2, wherein the one or more latches are recesses along a longitudinal edge of the engagement portion.

4. The system of claim 3, wherein each attachment point is elongated.

5. The system of claim 4, wherein each attachment point is a pocket.

6. The system of claim 5, further comprising a vehicular seat having an upper portion to which the engagement portion removable latches to.

7. The system of claim 6, wherein the upper portion comprises one or more headrest bases to which the one or more latches abut.

8. The system of claim 6, wherein the upper portion comprises one or more headrest supports to which the one or more latches abut.

9. The system of claim 6, further comprising a seat covering extending from a proximal end of the extension portion.

10. The system of claim 1, wherein the engagement portion is a horizontal bar.

11. The system of claim 10, wherein the extension portion comprises a pliable material.

12. The system of claim 11, wherein the pliable material is a fabric.

13. An attachment system, the system comprising:
an elongate engagement portion having one or more attachment portion connecting to a first object; and
an extension portion having a plurality of elongated pockets, wherein the elongated engagement portion removably slides in one of the plurality of elongated pockets, and wherein the plurality of elongated pockets are linearly spaced apart relative to each other wherein a distance between the elongated engagement portion and a proximal end of the extension portion is adjustable between two or more connections to the first object, and wherein the proximal end connects to a second object.
